(19) United States
(12) Patent Application Publication
(10) Pub. No.: US 2020/0350634 A1
(43) Pub. Date: Nov. 5, 2020

(54) CYLINDRICAL SECONDARY BATTERY

(71) Applicant: PANASONIC INTELLECTUAL PROPERTY MANAGEMENT CO., LTD., Osaka (JP)

(72) Inventor: Yuki SUEHIRO, Osaka (JP)

(21) Appl. No.: 16/762,720

(22) PCT Filed: Oct. 31, 2018
(86) PCT No.: PCT/JP2018/040426

§ 371 Date: May 8, 2020

(30) Foreign Application Priority Data
Nov. 16, 2017 (JP) 2017-221317

(51) Int. Cl. H01M 10/0587; H01M 2/26; H01M 10/0525; H01M 2/16; H01M 4/70; H01M 4/36

(52) U.S. Cl. CPC H01M 10/0587; H01M 2/263; H01M 10/0525; H01M 2004/028; H01M 4/70; H01M 4/366; H01M 2/1673

(57) ABSTRACT

A cylindrical secondary battery including an electrode group which includes a first columnar region in which the number of times positive electrode mixture layers are stacked in the radial direction of the electrode group is highest and a second columnar region. The first columnar region includes a 1A arc column region that includes an outer periphery-side end surface of the positive electrode mixture layers and a 1B arc column region that does not include the end surface. The negative electrode current collector includes a first exposed part located on the periphery of the negative electrode. The negative electrode current collection lead includes an overlap part that overlaps the first exposed part and a lead-out part. The overlap part of the negative electrode current collection lead is not located on the boundary between the 1A arc column region and the second columnar region of the electrode group.

### TECHNICAL FIELD

The present invention relates to a cylindrical secondary battery that includes a wound electrode group.

### BACKGROUND ART

The range of applications of devices that use a battery has been extended. In particular, lithium-ion secondary batteries, which are light in weight and have high capacities and high powers, have been widely used as a power source for driving portable electronic devices, such as a notebook-sized personal computer and a mobile phone. In such applications, high-capacity lithium-ion secondary batteries having a diameter of about 14 to 18 mm and a height of about 40 to 65 mm have been widely used.

High-capacity lithium-ion secondary batteries commonly include a wound electrode group including a positive electrode, a negative electrode, and a separator interposed therebetween which are wound into a spiral. In the wound electrode group described in PTL 1, the separator is located on the outermost periphery of the electrode group and is fixed in position with a fixing tape. The fixing tape is arranged not to overlap the winding ends of the electrodes. According to PTL 1, the likelihood of a bump being created at the winding ends of the electrodes is reduced and, consequently, the rupture of the electrodes can be reduced.

### CITATION LIST

### Patent Literature

PTL 1: Japanese Published Unexamined Patent Application No. 2010-212086

### SUMMARY OF INVENTION

When a negative electrode current collector and a battery casing are connected to each other with a negative electrode current collection lead in a cylindrical secondary battery, an end of the negative electrode current collection lead is joined to the negative electrode current collector and the other end is joined to the inner wall of the battery casing. Accordingly, an electrode group including the negative electrode current collection lead joined thereto is likely to be elliptical as a result of a portion of the electrode group to which the negative electrode current collection lead is joined becoming protruded. In such a case, when the electrode group becomes expanded during charging, a high stress is applied between the protruded portion of the electrode group and the battery casing. This increases the risk of damage to the electrode group and consequently reduces cycle characteristics.

An aspect of the present invention relates to a cylindrical secondary battery including a closed-end cylindrical battery casing having an opening; an electrode group disposed in the battery casing, the electrode group including a positive electrode, a negative electrode, and a separator interposed between the positive electrode and the negative electrode; a nonaqueous electrolyte disposed in the battery casing; a sealing member filling the opening of the battery casing; and a negative electrode current collection lead connecting the negative electrode and the battery casing to each other. The positive electrode includes a positive electrode current collector and positive electrode mixture layers disposed on respective principal surfaces of the positive electrode current collector. The negative electrode includes a negative electrode current collector and negative electrode mixture layers disposed on respective principal surfaces of the negative electrode current collector. The electrode group is formed as a result of the positive electrode and the negative electrode being wound into a spiral with the separator interposed therebetween and includes a first columnar region in which the number of times the positive electrode mixture layers are stacked in the radial direction of the electrode group is highest and a second columnar region other than the first columnar region. The first columnar region includes a 1A arc column region that includes an outer periphery-side end surface of the positive electrode mixture layers and a 1B arc column region that does not include the end surface. The 1A arc column region and the 1B arc column region are arranged to face each other such that the central angles thereof are vertically opposite to each other. The negative electrode current collector includes a first exposed part on which the negative electrode mixture layers are not disposed, the first exposed part being located on the outermost periphery of the negative electrode. The negative electrode current collection lead includes an overlap part that overlaps the first exposed part and a lead-out part protruded from the first exposed part. The overlap part of the negative electrode current collection lead is not located on the boundary between the 1A arc column region and the second columnar region of the electrode group.

According to the present invention, a cylindrical battery having excellent cycle characteristics may be provided.

### BRIEF DESCRIPTION OF DRAWINGS

FIG. 1 is a schematic cross-sectional view of a wound electrode group, illustrating the structure of the wound electrode group.

FIG. 2 includes a schematic plan view (a) of an example of a positive electrode according to an embodiment of the present invention and a cross-sectional view (b) of the example of a positive electrode taken along the line Ib-Ib.

FIG. 3 includes a schematic plan view (a) of an example of a negative electrode according to an embodiment of the present invention and a cross-sectional view (b) of the example of a negative electrode taken along the line IIb-IIb.

FIG. 4 is a schematic plan view of a negative electrode current collection lead joined to a first exposed part of a negative electrode current collector.

FIG. 5A is a schematic diagram illustrating a positional relationship between a first columnar region and a negative electrode current collection lead.

FIG. 5B is a schematic diagram illustrating another positional relationship between a first columnar region and a negative electrode current collection lead.

FIG. 6 is a longitudinal cross-sectional view of a cylindrical secondary battery according to an embodiment of the present invention.

FIG. 7A is a schematic diagram illustrating a positional relationship between a first columnar region and a negative electrode current collection lead in Example 1.

FIG. 7B is a schematic diagram illustrating a positional relationship between a first columnar region and a negative electrode current collection lead in Example 2.

FIG. 7C is a schematic diagram illustrating a positional relationship between a first columnar region and a negative electrode current collection lead in Example 3.

FIG. 7D is a schematic diagram illustrating a positional relationship between a first columnar region and a negative electrode current collection lead in Example 4.

FIG. 7E is a schematic diagram illustrating a positional relationship between a first columnar region and a negative electrode current collection lead in Example 5.

FIG. 8A is a schematic diagram illustrating a positional relationship between a first columnar region and a negative electrode current collection lead in Comparative example 1.

FIG. 8B is a schematic diagram illustrating a positional relationship between a first columnar region and a negative electrode current collection lead in Comparative example 2.

FIG. 8C is a schematic diagram illustrating a positional relationship between a first columnar region and a negative electrode current collection lead in Comparative example 3.

### DESCRIPTION OF EMBODIMENTS

A cylindrical secondary battery according to the embodiment includes a closed-end cylindrical battery casing having an opening; an electrode group and a nonaqueous electrolyte disposed in the battery casing; a sealing member that fills the opening of the battery casing; and a negative electrode current collection lead that connects the negative electrode and the battery casing to each other. The electrode group is a wound electrode group that includes a positive electrode, a negative electrode, and a separator interposed between the positive electrode and the negative electrode and is formed as a result of the positive electrode and the negative electrode being wound into a spiral with the separator interposed therebetween (hereinafter, this wound electrode group may be referred to simply as “electrode group”).

A wound electrode group necessarily includes a columnar region in which the number of times electrodes are stacked in the radial direction is higher and a columnar region in which the above number is lower. For example, when the apparent number of positive electrodes (the number of times the positive electrode are stacked) in the radial direction of the electrode group is counted, the above number is higher in a particular region than in the other region. Accordingly, the diameter of the electrode group is larger in the particular region and a cross section of the electrode group becomes elliptical. When the electrode group becomes expanded during charging, the battery casing applies a stress to the electrode group such that the major-axis length of the ellipse is reduced. The stress is high particularly when the battery casing is made of stainless steel having a high strength.

In the case where a negative electrode current collection lead is joined to the particular region in which the above number is higher, the major-axis length of the ellipse is further increased and the above stress is increased accordingly. Since this stress concentrates particularly at the end surface of a region (positive electrode both-side coated part) in which the positive electrode mixture layers are disposed on the respective surfaces (more specifically, at the edges of the positive electrode mixture layers), a negative electrode current collector located at a position corresponding to the end surface is likely to become damaged. The negative electrode current collector may rupture when the cycle of charging and discharging is repeated. The term “end surface” used herein refers to a cross section taken in the thickness direction.

The negative electrode current collector is more likely to become damaged particularly when the negative electrode current collection lead is located on the outer periphery-side end surface of the positive electrode both-side coated part in the region in which the number of times the positive electrode is stacked is higher. The damage to the negative electrode current collector is likely to be further increased when the cylindrical secondary battery has a diameter of 10 mm or less (hereinafter, such a cylindrical secondary battery may be referred to as “pin-shaped battery”). This is because, in a pin-shaped battery, the proportion of the thickness of the negative electrode current collection lead to the diameter of the electrode group is high and the ratio of the major-axis length to the minor-axis length of the ellipse is increased accordingly.

Accordingly, in this embodiment, the negative electrode current collection lead is joined to the negative electrode current collector such that the negative electrode current collection lead is located on the outer periphery-side end surface of the positive electrode both-side coated part, that is, the boundary between a portion of the region (first columnar region) in which the number of times the positive electrode mixture layers are stacked is higher, the portion (1A arc column region) including the outer periphery-side end surface of the positive electrode mixture layers, and a region other than the first columnar region (second columnar region). This mitigates the concentration of the stress at a portion of the negative electrode current collector which corresponds to the above boundary and consequently reduces the damage to the negative electrode current collector. As a result, suitable cycle characteristics may be achieved.

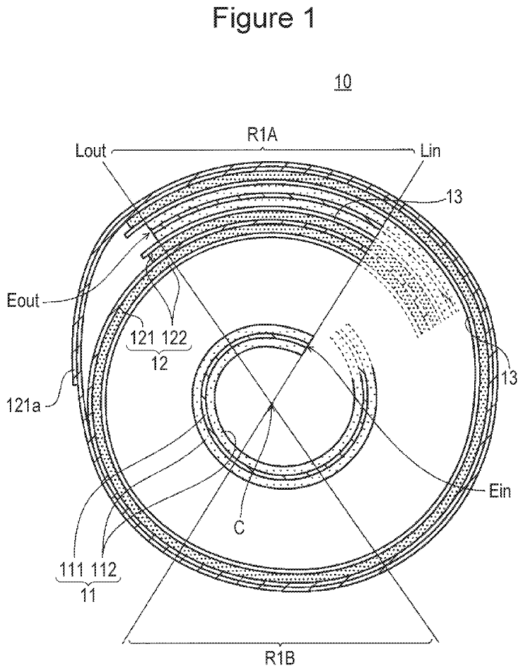

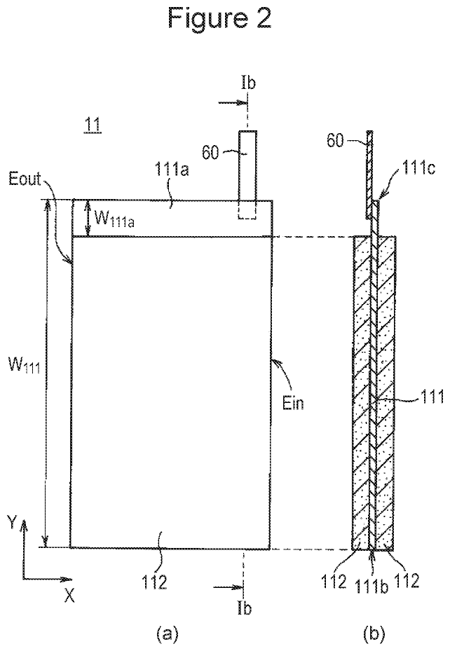

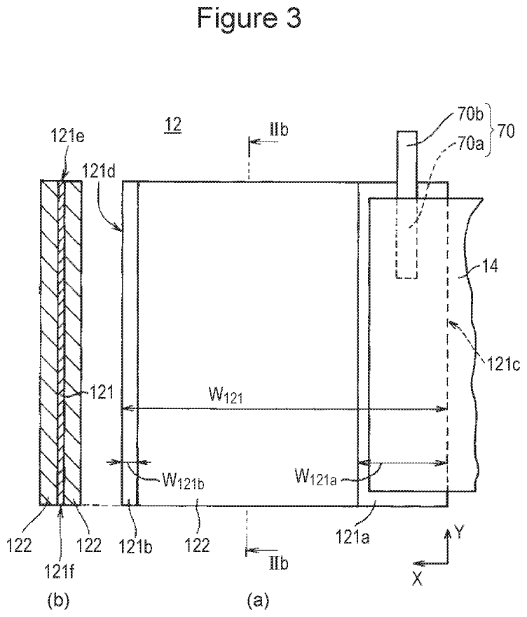

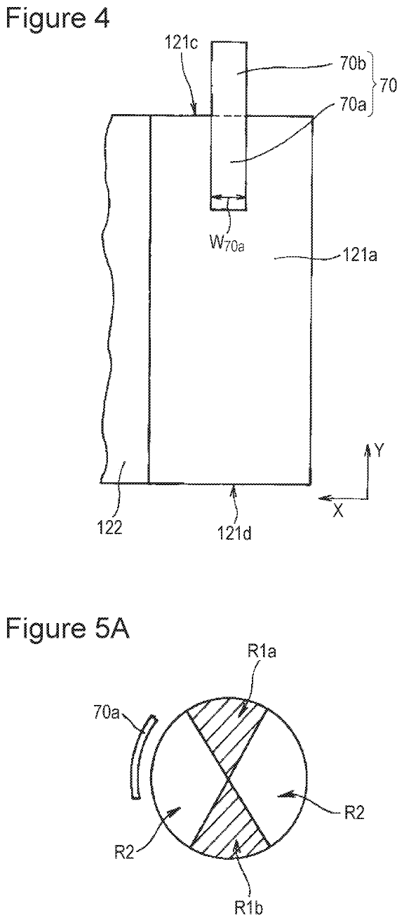

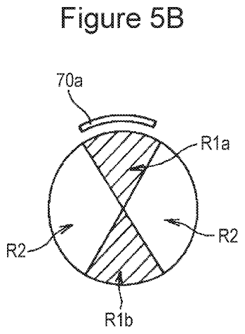

The wound electrode group according to the embodiment is described in detail below with reference to the attached drawings. FIG. 1 is a schematic cross-sectional view of the wound electrode group, illustrating the structure of the wound electrode group. FIG. 2 includes a schematic plan view (a) of an example of the positive electrode and a cross-sectional view (b) of the example of the positive electrode taken along the line Ib-Ib. FIG. 3 includes a schematic plan view (a) of the negative electrode and a cross-sectional view (b) of the negative electrode taken along the line IIb-IIb. FIG. 4 is a schematic plan view of a negative electrode current collection lead joined to an exposed part (first exposed part) of a negative electrode current collector. FIGS. 5A and 5B are schematic diagrams illustrating a positional relationship between a first columnar region and an overlap part of the negative electrode current collection lead in the cross-sectional view illustrated in FIG. 1.

A wound electrode group 10 includes a positive electrode 11, a negative electrode 12, and a separator 13 interposed therebetween, which are wound into a spiral to form the wound electrode group 10. The shape of the cylindrical electrode group may be a shape similar to a cylinder, such as the shape of a cylinder partially bent or the shape of a cylinder slightly crushed in the radial direction.

The positive electrode 11 includes a positive electrode current collector 111 and positive electrode mixture layers 112 disposed on the respective principal surfaces of the positive electrode current collector 111. That is, the positive electrode 11 includes a region in which the positive electrode mixture layers 112 are disposed on the respective surfaces (hereinafter, this region is referred to as “positive electrode both-side coated part”). Hereinafter, the end surface of the positive electrode both-side coated part which is closer to the outer periphery is referred to as “end surface Eout”, while the end surface of the positive electrode both-side coated part which is closer to the inner periphery is referred to as “end surface Ein”. The end surfaces of the positive electrode both-side coated part are the end surfaces of the region in which the positive electrode mixture layers 112 are disposed on the respective surfaces. In the case where the positions of the ends of the positive electrode mixture layers 112 disposed on the respective surfaces are different from each other, the end surface of the positive electrode both-side coated part corresponds to a cross section of the positive electrode 11 taken along the end surface of one of the positive electrode mixture layers 112 the end of which in the winding axis direction is closer to the winding axis. In the case where the positions of the ends of the positive electrode mixture layers 112 disposed on the respective surfaces are the same as each other, the end surface of the positive electrode both-side coated part includes the end surfaces of the positive electrode mixture layers 112 disposed on the respective surfaces.

FIG. 2 is a developed view of the positive electrode 11. In the example illustrated in the drawing, the ends of the positive electrode 11 in the X-direction correspond to the end surfaces Eout and Ein of the positive electrode both-side coated part. That is, the X-direction corresponds to the winding direction; the positive electrode mixture layers 112 are arranged to extend to the ends of the positive electrode current collector 111 in the X-direction; and the sizes and positions of the positive electrode mixture layers 112 disposed on the respective surfaces are the same as each other. In this case, the size of a bump created at the end of the positive electrode 11 in the winding axis direction (Y-direction) is particularly large. However, according to the embodiment, the negative impact of the end surface of the positive electrode both-side coated part on the negative electrode current collector 121 can be reduced.

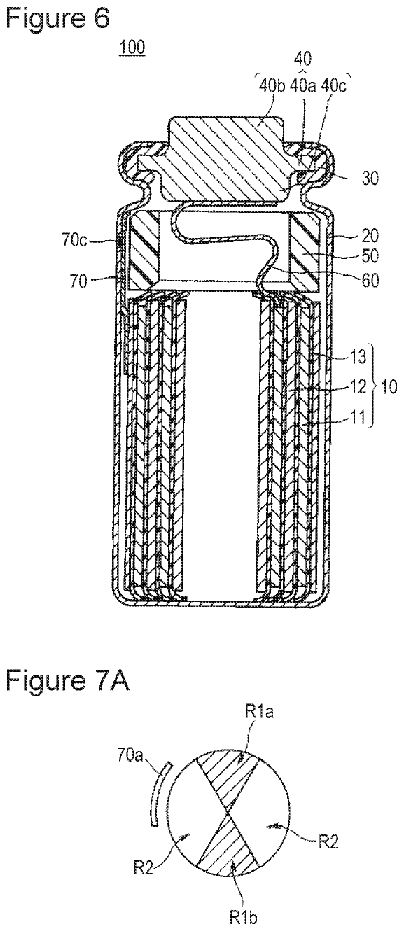

The positive electrode 11 is provided with a positive electrode current collection lead 60 that connects the positive electrode 11 to a sealing member (see FIG. 6) and is welded to the positive electrode 11. The positive electrode current collection lead 60 is joined to an exposed part (second exposed part 111a) of the positive electrode current collector 111 on which the positive electrode mixture layers 112 are not disposed. In the case where the ends of the positive electrode 11 in the winding direction (X-direction) correspond to the end surfaces Eout and Ein of the positive electrode both-side coated part, the second exposed part 111a is arranged to extend in the X-direction of the positive electrode current collector 111 along an end (the end on the end surface 111c-side) facing the opening of the battery casing.

On the other hand, the positive electrode current collector 111 is not exposed at the other end (the end on the end surface 111b-side) of the positive electrode 11 in the Y-direction; the positive electrode mixture layers 112 are disposed all over the surfaces except the end surface 111b. The width W₁₁₂ of the positive electrode mixture layers 112 in the winding axis direction is slightly smaller than the width of the negative electrode mixture layers 122 in the winding axis direction. When the positive electrode mixture layers 112 and the negative electrode mixture layers 122 are wound into a spiral, the positive electrode mixture layers 112 fully overlap the negative electrode mixture layers 122.

The width W₁₁₁ of the positive electrode current collector 111 in the Y-direction may be selected appropriately in accordance with the length of the battery casing or the capacity of the battery. The width W₁₁₁ₐ of the second exposed part 111a in the Y-direction may be, for example, 1 to 5 mm.

The negative electrode 12 includes a negative electrode current collector 121 and a negative electrode mixture layer 122 disposed on at least one of the principal surfaces of the negative electrode current collector 121. The negative electrode current collector 121 includes a first exposed part on which the negative electrode mixture layer 122 is not disposed. The first exposed part is located on the outermost periphery of the negative electrode 12.

FIG. 3 is a developed view of the negative electrode 12. In the example illustrated in the drawing, a first exposed part 121a is formed on an end (an end on the end surface 121c-side) located on the outermost periphery of the negative electrode 12 in the X-direction so as to extend from an end (an end on the end surface 121e-side) of the negative electrode current collector 121 in the Y-direction to the other end (the end on the end surface 121f-side). In this case, the negative electrode mixture layer 122 is not disposed in a region formed by extending the overlap part 70a of the first exposed part 121a in the Y-direction. Therefore, the thickness of the overlap part 70a significantly affects the negative electrode current collector 121. According to the embodiment, the negative impact of the negative electrode current collection lead 70 (the overlap part 70a) on the negative electrode current collector 121 can be reduced.

The negative electrode current collector 121 is rectangular. The length of the negative electrode current collector 121 in the X-direction is set to be larger than that of the positive electrode current collector 111. The first exposed part 121a is provided with an insulating tape 14 disposed thereon so as to cover the overlap part 70a of the negative electrode current collection lead 70. The insulating tape 14 fixes the outermost periphery of the wound electrode group 10 in position. That is, the insulating tape 14 is responsible both for the protection of the negative electrode current collection lead 70 and for the fixation of the electrode group 10.

A strip-like third exposed part 121b at which the negative electrode current collector 121 is exposed is formed on the other end (the end on the end surface 121d-side) of the negative electrode 12 in the X-direction. The third exposed part 121b is located on the inner periphery-side of the wound electrode group.

The width W₁₂₁ₐ of the first exposed part 121a in the X-direction may be selected appropriately in consideration of the width W₇₀ₐ of the overlap part 70a in the winding direction, the diameter of the electrode group 10, and the like. The width W₁₂₁ₐ is, for example, 10% to 50% of the width W₁₂₁ of the negative electrode current collector 121 in the X-direction. The width W_{121b} of the third exposed part 121b in the X-direction is, for example, 3% to 10% of the width W₁₂₁.

The ends of the negative electrode 12 in the Y-direction are covered with the negative electrode mixture layers 122 except the end surfaces 121e and 121f of the respective ends and portions corresponding to the first exposed part 121a and the third exposed part 121b. Alternatively, the negative electrode mixture layer 122 may be disposed in at least a part of the regions of any one of the principal surfaces of the negative electrode 12 which correspond to the first exposed part 121a and/or the third exposed part 121b.

FIG. 4 schematically illustrates the negative electrode current collection lead 70 joined to the first exposed part 121a of the negative electrode current collector 121. The negative electrode current collection lead 70 includes an overlap part 70a that overlaps the first exposed part 121a and a lead-out part 70b protruded from the first exposed part 121a. The negative electrode current collection lead 70 is welded to the first exposed part 121a at at least a portion of the overlap part 70a.

The negative electrode current collector 121 is exposed at least one of the surfaces of the first exposed part 121a which faces the overlap part 70a; the negative electrode mixture layer 122 may be disposed on the other surface. However, it is preferable that the negative electrode mixture layer 122 be not disposed on either of the surfaces of the first exposed part 121a in order to increase ease of welding the negative electrode current collection lead 70 to the negative electrode current collector 121.

The electrode group 10 includes a region (first columnar region R1) in which the number of times the positive electrode mixture layers 112 are stacked is highest. The number of times the positive electrode mixture layers 112 are stacked is determined by counting, in the positive electrode both-side coated part, the number of pairs of the positive electrode mixture layers 112 disposed on the respective surfaces of the positive electrode current collector 111 which are present on the diameter of the electrode group 10. That is, the first columnar region R1 includes two arc columnar regions defined by the straight line Lout that connects the end surface Eout of the both-side coated part to the center C of the cylindrical secondary battery 100 and the straight line Lin that connects the end surface Ein of the positive electrode both-side coated part to the center C of the cylindrical secondary battery 100, as illustrated in FIG. 1. The two arc columnar regions (the 1A arc column region R1A and the 1B arc column region R1B) are arranged to face each other such that the central angles thereof are vertically opposite to each other.

The diameter of the electrode group 10 in the first columnar region R1 is larger than the diameter of the electrode group 10 in the second columnar region R2. In this case, when the electrode group 10 becomes expanded during charging, the stress generated between the electrode group 10 and the battery casing acts particularly to crush the first columnar region R1 toward the center of the electrode group 10.

In the case where the overlap part 70a of the negative electrode current collection lead 70 is located on the boundary between the first columnar region R1 and the second columnar region R2, the stress concentrates at the boundary. In the case where the negative electrode current collection lead 70 is located on the boundary between the 1A arc column region R1A of the first columnar region R1, which includes the outer periphery-side end surface Eout of the positive electrode both-side coated part, and the second columnar region R2, the stress concentrates particularly at the edge of the end surface Eout. Accordingly, when the negative electrode current collector 121 is disposed in the 1A arc column region R1A, the negative electrode current collector 121 is likely to be pressurized locally by the edge of the end surface Eout and become damaged.

In the first columnar region R1, the negative electrode mixture layer 122 is disposed in addition to the positive electrode 11. Since the positive electrode mixture layers 112 are relatively hard and resistant to the damage caused due to the above stress, the positive electrode current collector 111 is also resistant to the damage. Furthermore, the hard positive electrode mixture layers 112 are likely to transmit the stress to another component, that is, the negative electrode 12. On the other hand, since the negative electrode mixture layer 122 is relatively soft, the negative electrode mixture layer 122 becomes deformed to a certain degree due to the stress. As a result, the stress acts particularly on the negative electrode current collector 121.

In the embodiment, the damage to the negative electrode current collector 121 is reduced by arranging the overlap part 70a not to overlap the boundary between the 1A arc column region R1A and the second columnar region R2.

The position of the negative electrode current collection lead 70 is not limited and may be any position such that the overlap part 70a is not located on the boundary between the 1A arc column region R1A and the second columnar region R2. For example, the entirety of the overlap part 70a may be disposed in a region (the 1B arc column region R1B or the second columnar region R2) other than the 1A arc column region R1A, as illustrated in FIG. 5A. Alternatively, the entirety of the overlap part 70a may be disposed in the 1A arc column region R1 so as not to overlap the above boundary, as illustrated in FIG. 5B.

In consideration of cycle characteristics, it is preferable that the entirety of the overlap part 70a be disposed in a region other than the 1A arc column region R1A and it is more preferable that the entirety of the overlap part 70a be disposed in a region other than the 1A arc column region R1A or the 1B columnar region R1B (i.e., the second columnar region R2). From the same viewpoint as mentioned above, the overlap part 70a is preferably arranged not to be located on the boundary between the 1B arc column region R1B and the second columnar region R2. In such a case, the shape of the electrode group 10 approaches that of a perfect circle and, even when the electrode group 10 becomes expanded during charging, the concentration of the stress in the vicinity of the negative electrode current collection lead of the electrode group is mitigated. As a result, cycle characteristics may be readily enhanced.

The number of times the positive electrode mixture layers 112 are stacked on the diameter of the electrode group 10 may be set appropriately in consideration of the intended capacity, the diameter of the electrode group 10, etc. The number of times the positive electrode mixture layers 112 are stacked may be, for example, 6 or more and 20 or less and may be 6 or more and 16 or less. When the above number falls within the above range, the thickness of each positive electrode mixture layer 112 can be set to be adequate. This enables the achievement of a high capacity and enhances the advantageous effects of the embodiment.

The first exposed part 121a may be disposed on the outermost periphery of the electrode group 10. In such a case, the length (width) W₇₀ₐ of the overlap part 70a of the negative electrode current collection lead 70 in the winding direction may be 10% or more and 30% or less of the length of the outermost periphery of the electrode group 10 in the winding direction. Even in the case where the width W₇₀ₐ of the overlap part 70a is relatively large as described above, arranging the overlap part 70a not to be located on the boundary between the 1A arc column region R1A and the second columnar region R2 may reduce the negative impact of the edge of the end surface Eout of the positive electrode both-side coated part on the negative electrode current collector 121.

The outermost periphery of the electrode group 10 may be covered with the first exposed part 121a. In such a case, it becomes easy to arrange the overlap part 70a of the negative electrode current collection lead 70 not to overlap the 1A arc column region R1A and the first columnar region R1.

The thickness of the negative electrode current collection lead 70 may be 0.3% to 3% of the outside diameter of the cylindrical secondary battery. Even in the case where the proportion of the negative electrode current collection lead 70 in the radial direction of the battery is high as described above, according to the embodiment, the negative impact of the edge of the end surface Eout of the positive electrode both-side coated part on the negative electrode current collector 121 can be reduced.

The separator 13 is, for example, an extra-long rectangular body. The length of the separator 13 in the X-direction is set to be larger than the lengths of the positive electrode mixture layers 112 and/or the negative electrode mixture layer 122. The ends of the separator 13 in the winding axis direction are protruded from the corresponding ends of the positive electrode 11 and the negative electrode 12. At least a portion of the first exposed part 121a of the negative electrode 12 is protruded from the separator 13. The protruded portion is arranged to face the inner surface of the side wall of the battery casing with the insulating tape 14 interposed therebetween.

The length of the insulating tape 14 in the X-direction is preferably 50% or more of the length of the outermost periphery of the electrode group 10 in the X-direction. In such a case, the deformation of the electrode group 10 which may be caused by the insulating tape 14 can be reduced and, consequently, the damage to the negative electrode current collector 121 may be further reduced.

The diameter of the electrode group 10 is not limited. The diameter of the electrode group 10 may be 6 mm or less and may be 5 mm or less. The diameter of the electrode group 10 may be 1 mm or more and may be 2 mm or more. The diameter of the electrode group 10 is the diameter of an equivalent circle of the electrode group 10 in a cross section orthogonal to the winding axis direction (i.e., a circle having an area equal to that of the electrode group 10 in the cross section).

The outside diameter of the cylindrical secondary battery 100 is not limited. The outside diameter of the cylindrical secondary battery 100 may be 6.5 mm or less and may be 5 mm or less. The outside diameter of the cylindrical secondary battery 100 may be 1 mm or more, may be 2 mm or more, and may be 3 mm or more. The outside diameter of the cylindrical secondary battery 100 is the maximum diameter of the battery casing.

The components of the cylindrical secondary battery are specifically described below. Although a cylindrical lithium-ion secondary battery is described as an example in this embodiment, the present invention is not limited to this.

(Positive Electrode)

The positive electrode included in the electrode group includes a positive electrode current collector and positive electrode mixture layers disposed on the respective principal surfaces of the positive electrode current collector.

The positive electrode current collector may be composed of a metal foil, such as an aluminum foil and/or an aluminum alloy foil. The thickness of the positive electrode current collector is not limited. The thickness of the positive electrode current collector may be 10 to 50 μm in consideration of a reduction in the size of the battery and the strength of the positive electrode current collector.

The thickness of the positive electrode mixture layer (the positive electrode mixture layer disposed on one of the surfaces of the positive electrode current collector) may be 20 to 100 μm or 30 to 70 μm. The overall thickness of the positive electrode may be, for example, 80 to 180 μm.

The positive electrode mixture layers include a positive electrode active material. The positive electrode active material is not limited and may be any material that can be used for lithium-ion secondary batteries. Examples of the positive electrode active material include lithium transition metal oxides, such as lithium cobalt oxide (LiCoO₂), lithium nickel oxide (LiNiO₂), and lithium manganate (LiMn₂O₄); and lithium composite oxides produced by replacing some of the Co, Ni, or Mn atoms included in the above compounds with other elements (e.g., a transition metal element and/or a representative element). The above positive electrode active materials may be used alone or in combination of two or more.

The positive electrode active material may be a lithium composite oxide in order to reduce the size of the battery and increase energy density. Specific examples of the lithium composite oxide include a composite oxide represented by General Formula: Liₓ₁Ni_{y1}M^{a}_{1-y1}O₂(1) and/or a composite oxide represented by General Formula:

Liₓ₂Ni_{y2}CO_{z1}M^{b}_{1-y2-z1}O₂ (2).

In Formula (1), the element M^{a} is, for example, at least one element selected from the group consisting of Na, Mg, Sc, Y, Mn, Fe, Co, Cu, Zn, Al, Cr, Pb, Sb, and B; x1 and y1 satisfy, for example, 0<x≤1.2 and 0.5<y1≤1.0, respectively; and x1 is a value that varies during charging and discharging.

In Formula (2), the element M^{b} is, for example, at least one element selected from the group consisting of Mg, Ba, Al, Ti, Sr, Ca, V, Fe, Cu, Bi, Y, Zr, Mo, Tc, Ru, Ta, and W; x2, y2, and z1 satisfy, for example, 0<x2≤1.2 (preferably, 0.9≤x2≤1.2), 0.3≤y2≤0.9, and 0.05≤z1≤0.5, respectively; and x2 is a value that varies during charging and discharging. In Formula (2), 0.01≤1−y2−z1≤0.3 may be satisfied.

The positive electrode mixture layers may include a binding agent and/or a conductant agent as needed. The binding agent may be any binding agent used for lithium-ion secondary batteries. Specific examples of the binding agent include fluororesins, such as polyvinylidene fluoride (PVdF); rubber-like polymers, such as a styrene-butadiene rubber and a fluorine-containing rubber; and/or polyacrylic acid. The amount of the binding agent included in the positive electrode mixture layers is, for example, 1 to 5 parts by weight relative to 100 parts by mass of the positive electrode active material.

The conductant agent may be any conductant agent used for lithium-ion secondary batteries. Specific examples of the conductant agent include carbonaceous materials, such as graphite, carbon black, and carbon fibers; metal fibers; and/or organic conductive materials. In the case where the positive electrode mixture layers include a conductant agent, the amount of the conductant agent included in the positive electrode mixture layers is, for example, 0.5 to 5 parts by mass relative to 100 parts by mass of the positive electrode active material.

The positive electrode can be formed by applying a positive electrode slurry that includes the positive electrode active material and a dispersion medium onto the surfaces of the positive electrode current collector, drying the resulting coatings, and then compressing the coatings in the thickness direction. The binding agent and/or the conductant agent may be added to the positive electrode slurry. Examples of the dispersion medium include water; an organic solvent, such as N-methyl-2-pyrrolidone (NMP); and a mixed solvent thereof.

(Negative Electrode)

The negative electrode includes a negative electrode current collector and a negative electrode mixture layer disposed on a portion of at least one of the principal surfaces of the negative electrode current collector.

The negative electrode current collector may be a metal foil, such as a copper foil and/or a copper alloy foil. Since copper has a low resistivity, using a negative electrode current collector including copper makes it easy to achieve a high power.

The negative electrode mixture layer may be disposed only one of the surfaces of the negative electrode current collector. In order to achieve a high capacity, the negative electrode mixture layer may be disposed on both of the surfaces of the negative electrode current collector. As in the case for the positive electrode mixture layers, the negative electrode mixture layer may be disposed on only one of the surfaces of the negative electrode current collector at the winding start and/or the winding end of the wound electrode group. In another case, a region in which the negative electrode mixture layer is not disposed may be formed on both of the corresponding principal surfaces of the negative electrode current collector.

The thickness of the negative electrode mixture layer (the negative electrode mixture layer disposed on one of the surfaces of the negative electrode current collector) may be 20 to 120 μm or 35 to 100 μm. The overall thickness of the negative electrode is, for example, 80 to 250 μm.

The negative electrode mixture layer includes a negative electrode active material. The negative electrode active material may be any carbon material that can be used for lithium-ion secondary batteries. Examples of the negative electrode active material include a carbonaceous material capable of occluding and releasing lithium ions. Examples of the carbonaceous material include graphite materials (e.g., natural graphite and artificial graphite) and amorphous carbon materials.

The negative electrode mixture layer may optionally include a binding agent and/or a thickener as needed.

The binding agent may be any binding agent used for lithium-ion secondary batteries. Examples of such a binding agent include compounds that are the same as the binding agents that can be added to the positive electrode mixture layers. Since the above binding agents may include a material (e.g., PVdF) capable of swelling with a nonaqueous electrolyte, the negative electrode mixture layer may retain a nonaqueous electrolyte. This may limit the drying up of the negative electrode to some degree. According to the embodiment, a particularly large amount of nonaqueous electrolyte can be retained in the inner peripheral portion of the electrode group. Consequently, cycle characteristics may be enhanced even when a cycle of charging and discharging including quick charging is repeated.

The thickener may be any thickener used for lithium-ion secondary batteries. Examples of the thickener include cellulose ethers, such as carboxymethylcellulose (CMC).

The negative electrode can be formed in the same manner as for the positive electrode. A negative electrode slurry includes the negative electrode active material and a dispersion medium and may further include a binding agent and/or a thickener as needed. The dispersion medium can be selected appropriately from the dispersion media for the positive electrode which are described above as an example.

(Separator)

The separator has a high ion permeability. The separator has, for example, an adequate mechanical strength and an insulating property. The separator may be any separator used for lithium-ion secondary batteries. Examples of the separator include a microporous membrane, a woven fabric, and/or a nonwoven fabric. The separator may be single-layer, composite-layer, or multilayer. The number of the types of materials included in the separator may be only one or two or more.

Examples of the material constituting the separator include the following resin materials: polyolefin resins, such as polypropylene and polyethylene; polyamide resins; and/or polyimide resins. The separator may be a microporous membrane including a polyolefin resin, because such a separator has excellent durability and a function of blocking pores when the temperature is increased to a certain temperature, that is, a “shut-down” function.

The thickness of the separator is not limited. For example, the thickness of the separator can be selected appropriately from the range of 5 to 300 μm. The thickness of the separator may be 5 to 40 μm and may be 5 to 30 μm.

(Insulating Tape)

The insulating tape is composed of a resin or the like. The type of the resin is not limited and may be any resin having an adequate elasticity, an adequate flexibility, and an insulating property. Examples of such a resin include polyimide, polyamide (e.g., aromatic polyamide), polyamide imide, polyolefin (e.g., polypropylene (PP)), polyester (e.g., polyethylene naphthalate), polyphenylsulfone (PPS), and polyphenylene sulfide. The above resins may be used alone or in combination of two or more.

The insulating tape includes an adhesive layer. This enables the winding end of the electrode group to be fixed in position. Various types of resin materials may be used as an adhesive. Examples of the adhesive include an acrylic resin, a natural rubber, a synthetic rubber (e.g., a butyl rubber), a silicone, an epoxy resin, a melamine resin, and a phenolic resin. The above resin materials may be used alone or in combination of plural types. The adhesive may optionally include additives, such as a tackifier, a crosslinking agent, an antioxidant, a colorant, an antioxidant, a chain transfer agent, a plasticizer, a softener, a surfactant, and an antistatic agent, as needed. The adhesive may also include a trace amount of solvent.

The thickness of the insulating tape may be 5 to 100 μm and may be 10 to 50 μm in consideration of ease of handling and flexibility. The thickness of the adhesive layer may be 2 to 30 μm and may be 5 to 15 μm in order to facilitate the achievement of high adhesion and the engineering design of the tape.

The structure of the cylindrical secondary battery according to the embodiment is described below with reference to the attached drawings. FIG. 6 is a schematic longitudinal cross-sectional view of the cylindrical secondary battery according to the embodiment of the present invention.

A cylindrical secondary battery 100 includes a closed-end cylindrical battery casing 20 having an opening, a wound electrode group 10 and a nonaqueous electrolyte (not illustrated in the drawing) disposed in the battery casing 20, and a sealing member 40 that fills the opening of the battery casing 20.

The sealing member 40 is hat-like and includes a ring-like brim 40a and solid-cylindrical terminal parts 40b and 40c protruded from the inner periphery of the brim 40a in the thickness direction. A ring-like insulating gasket 30 is disposed on the periphery of the sealing member 40 so as to cover the brim 40a. The opening end of the battery casing 20 is bent inward and crimped onto the periphery of the sealing member 40 with the gasket 30 interposed therebetween. This provides insulation between the battery casing 20 and the sealing member 40 and seals the battery casing 20.

A space is created between the upper end surface (upper surface) of the electrode group 10 and the bottom surface of the sealing member 40. An insulating ring 50 is disposed in the space and limits the contact between the electrode group 10 and the sealing member 40. The insulating ring 50 may be combined with the gasket 30. Optionally, an insulating ring composed of an electrically insulative material may be arranged to cover the outer surface of the curved opening end of the battery casing 20 and a portion of the surface of the gasket 30 which is in the vicinity thereof.

In this embodiment, the battery casing 20 serves as an outer negative terminal and the sealing member 40 serves as an outer positive terminal. A negative electrode current collection lead 70 is drawn from the negative electrode 12 disposed at a position closest to the outer periphery of the electrode group 10 and is connected to the inner wall of the battery casing 20. The negative electrode current collection lead 70 drawn is connected to the inner wall of the battery casing 20 at a welding point 70c. This provides an electrical connection between the negative electrode 12 and the battery casing 20 with the negative electrode current collection lead 70 and enables the battery casing 20 to serve as an outer negative terminal. The welding point 70c is disposed, for example, at a portion of the inner wall of the battery casing 20 which is closer to the opening of the battery casing 20 than the upper end surface of the electrode group 10.

One of the ends of the positive electrode current collection lead 60 is connected to the positive electrode 11 (e.g., the second exposed part 111a) by welding or the like. The other end is connected to the bottom surface of the sealing member 40 by welding or the like, through a hole formed at the center of the insulating ring 50. This provides an electrical connection between the positive electrode 11 and the sealing member 40 with the positive electrode current collection lead 60 and enables the sealing member 40 to serve as an outer positive terminal.

(Battery Casing)

The battery casing 20 has a shape of a closed-end cylinder having an opening. The battery casing 20 accommodates the wound electrode group 10 and a nonaqueous electrolyte.

The thickness (maximum thickness) of the bottom of the battery casing 20 may be 0.08 to 0.2 mm and may be 0.09 to 0.15 mm. The thickness (maximum thickness) of the side wall of the battery casing 20 may be 0.08 to 0.2 mm and may be 0.08 to 0.15 mm. The above thicknesses are the thicknesses of the bottom and side wall of the battery casing 20 of the cylindrical secondary battery 100 measured after the assembling of the cylindrical secondary battery 100.

The battery casing 20 is, for example, a metal can. Examples of the material constituting the battery casing 20 include aluminum, an aluminum alloy (e.g., an alloy containing a trace amount of metal other than aluminum, such as manganese or copper), iron, and/or an iron alloy (including stainless steel). The battery casing 20 may be subjected to a plating process (e.g., nickel plating process). The material constituting the battery casing 20 can be selected appropriately in accordance with the polarity of the battery casing 20, etc. According to the embodiment, the damage to the negative electrode current collector can be reduced and suitable cycle characteristics can be achieved even when the material constituting the battery casing 20 includes stainless steel having a high strength.

(Sealing Member)

In the cylindrical secondary battery 100, the opening of the battery casing 20 is filled with the sealing member 40.

The shape of the sealing member 40 is not limited. Examples of the shape include a disc-like shape and a (hat-like) shape of a disc the center of which is protruded in the thickness direction. The sealing member 40 may, but does not necessarily, have a space created inside thereof. Examples of the hat-like sealing member include a sealing member including a ring-like brim and a terminal part protruded either downward or upward from the inner periphery of the brim in the thickness direction; and a sealing member as illustrated in the drawing which includes a ring-like brim 40a and terminal parts 40b and 40c protruded upward and downward, respectively, from the inner periphery of the brim 40a in the thickness direction. The latter sealing member has an outside shape of two hats superimposed on each other such that the brim 40a-side portions of the hats face each other. The protruded terminal parts may have a shape of a solid cylinder or a shape of a hollow cylinder having a top surface (or top and bottom surfaces). The sealing member 40 may be provided with a safety valve, which is not illustrated in the drawing.

Examples of the material constituting the sealing member 40 include aluminum, an aluminum alloy (e.g., an alloy containing a trace amount of metal other than aluminum, such as manganese or copper), iron, and/or an iron alloy (including stainless steel). The sealing member 40 may be subjected to a plating process (e.g., nickel plating process) as needed. The material constituting the sealing member 40 can be selected appropriately in accordance with the polarity of the sealing member 40, and the like.

Publicly known sealing methods may be used for filling the opening of the battery casing 20 with the sealing member 40. Sealing may be performed by welding. It is preferable to perform sealing by crimping the opening of the battery casing 20 and the sealing member 40 with the gasket 30 interposed therebetween. The crimp sealing can be performed by, for example, bending the opening end of the battery casing 20 inward toward the sealing member 40 with the gasket 30 interposed therebetween.

(Current Collection Leads)

Examples of the material constituting the positive electrode current collection lead 60 include metals, such as aluminum, titanium, and nickel; and alloys thereof. Examples of the material constituting the negative electrode current collection lead 70 include metals, such as copper and nickel; and alloys thereof.

The shapes of the current collection leads are not limited; the current collection leads may be, for example, wire-like or sheet-like (or ribbon-like). The width and/or thickness of the current collection lead connected to the inner wall of the battery casing 20 may be determined appropriately with consideration of the maintenance of ease of inserting the electrode group 10 into the battery casing 20 and/or the strength of the current collection lead and/or a reduction in the volume of the current collection lead in the battery casing 20. The width of a ribbon-like current collection lead may be 1 to 2 mm or 1 to 1.5 mm in order to maintain a certain degree of welding strength and save space.

The thickness of the current collection lead may be determined appropriately with consideration of, for example, the outside diameter of the cylindrical secondary battery 100, the strength of the current collection lead, and ease of insertion of the electrode group 10. Considering that the thickness of the negative electrode current collection lead 70 is preferably 0.3% to 3% of the outside diameter of the cylindrical secondary battery 100, the thickness of the current collection lead may be, for example, 0.03 to 0.15 mm or 0.05 to 0.1 mm.

(Gasket)

The gasket 30 is interposed between the opening (specifically, the opening end) of the battery casing 20 and the sealing member 40 (specifically, the periphery of the sealing member 40) to provide insulation therebetween and maintain the hermeticity of the cylindrical secondary battery 100.

The shape of the gasket 30 is preferably, but not limited to, ring-like in order to cover the periphery of the sealing member 40. In the case where the sealing member has a disc-like shape, the gasket 30 may have a shape with which the periphery of the disc can be covered. In the case where the sealing member has a hat-like shape, the gasket 30 may have a shape with which the periphery of the brim can be covered.

The material constituting the gasket 30 may be an insulative material, such as a synthetic resin. Examples of the insulative material include, but are not limited to, the materials used for the gaskets of lithium-ion secondary batteries. Specific examples of the insulative material include polyolefins, such as polypropylene and polyethylene; fluororesins, such as polytetrafluoroethylene and a perfluoroalkoxyethylene copolymer; polyphenylene sulfide; polyether ether ketone; polyamide; polyimide; and liquid crystal polymers. The above insulative materials may be used alone or in combination of two or more. The gasket 30 may optionally include publicly known additives (e.g., fillers, such as inorganic fibers).

(Nonaqueous Electrolyte)

The nonaqueous electrolyte includes, for example, a nonaqueous solvent and a solute (supporting electrolyte) dissolved in the nonaqueous solvent.

The supporting electrolyte may be any supporting electrolyte (e.g., lithium salt) used for lithium-ion secondary batteries.

The concentration of the supporting electrolyte in the nonaqueous electrolyte is not limited and is, for example, 0.5 to 2 mol/L.

Examples of the supporting electrolyte (lithium salt) include fluorine-containing acid lithium salts [e.g., lithium hexafluorophosphate (LiPF₆), lithium tetrafluoroborate (LiBF₄), and lithium trifluoromethanesulfonate (LiCF₃SO₃)]; chlorine-containing acid lithium salts [e.g., lithium perchlorate (LiClO₄)]; fluorine-containing acid imide lithium salts [e.g., lithium bis(trifluoromethylsulfonyl)imide (LiN(CF₃SO₂)₂), lithium bis(pentafluoroethylsulfonyl)imide (LiN(C₂F₅SO₂)₂), and lithium bis(trifluoromethylsulfonyl)(pentafluoroethylsulfonyl)imide (LiN(CF₃SO₂) (C₂F₅SO₂))]; and fluorine-containing acid methide lithium salts [e.g., lithium tris(trifluoromethylsulfonyl)methide (LiC(CF₃SO₂)₃)]. The above supporting electrolytes may be used alone or in combination of two or more.

Examples of the nonaqueous solvent include cyclic carbonates (including derivatives (e.g., substitution products including a substituent)), such as propylene carbonate, a derivative of propylene carbonate, EC, butylene carbonate, vinylene carbonate, and vinylethylene carbonate; chain carbonates, such as dimethyl carbonate, diethyl carbonate (DEC), and EMC; chain ethers, such as 1,2-dimethoxyethane, 1,2-diethoxyethane, trimethoxymethane, and ethylmonoglyme; cyclic ethers (including derivatives (e.g., substitution products including a substituent)), such as tetrahydrofuran, 2-methyltetrahydrofuran, a derivative of tetrahydrofuran, dioxolane, and a derivative of dioxolane; lactones, such as γ-butyrolactone; amides, such as formamide, N,N-dimethylformamide, and acetamide; nitriles, such as acetonitrile and propylnitrile; nitroalkanes, such as nitromethane; sulfoxides, such as dimethyl sulfoxide; and sulfolane compounds, such as sulfolane and methylsulfolane. The above nonaqueous solvents may be used alone or in combination of two or more.

(Insulating Ring)

The insulating ring 50 is interposed between the upper portion of the electrode group 10 and the sealing member 40.

The insulating ring may be any insulating ring used for lithium-ion secondary batteries. The material constituting the insulating ring may be any insulative material and may be appropriately selected from, for example, the materials for the gasket which are described above as an example. The insulating ring 50 may be combined with the gasket 30.

The structure of the cylindrical secondary battery 100, the composition of the nonaqueous electrolyte, etc. are not limited to the above-described examples; publicly known structures and compositions may be selected appropriately.

The present invention is specifically described on the basis of Examples and Comparative examples below. Note that, the present invention is not limited to Examples below.

[Evaluations]

Twenty batteries prepared in each of Examples and Comparative examples were subjected to 100 cycles of charging and discharging and evaluated in terms of the damage to the negative electrode current collector and capacity retention factor.

Charging and discharging of the batteries were performed under the following conditions.

Each of the batteries was charged at a constant current of 1C until the closed circuit voltage of the battery reached 4.35 V and subsequently discharged at a constant current of 1C until the closed circuit voltage of the battery reached 3 V. The set of charging and discharging was considered one cycle. Note that the charging and discharging were performed at 23° C. while the design capacity of the batteries was considered 1C.

### (Evaluation 1) Damage to Negative Electrode Current Collector

After the completion of the 100 cycles, the batteries were decomposed and the wound electrode group was removed from each of the batteries. Cross-sectional photographs of the electrode groups were captured. On the basis of the photographs, the number of batteries out of 20 batteries in which the damage to the negative electrode current collector was confirmed was counted.

### (Evaluation 2) Capacity Retention Factor

The average of the ratios (=100×C₁₀₀/C₀ (%)) of the discharge capacities C₁₀₀ measured after 100 cycles to the discharge capacities (initial discharge capacities C₀) measured after 3 cycles is calculated.

### Example 1

Twenty cylindrical secondary batteries 100 as illustrated in FIG. 6 were prepared in the following manner.

(1) Preparation of Positive Electrode

A positive electrode slurry was prepared by mixing 100 parts by mass of lithium cobaltate used as a positive electrode active material, 2 parts by mass of acetylene black used as a conductant agent, and 2 parts by mass of PVdF used as a binding agent with NMP used as a dispersion medium. The positive electrode slurry was applied to both of the surfaces of an aluminum foil (thickness: 15 μm) used as a positive electrode current collector. After drying had been performed, compression was performed in the thickness direction. Hereby, a positive electrode 11 (thickness: 0.08 mm) was prepared. When the positive electrode 11 was prepared, a region (second exposed part 111a) in which positive electrode mixture layers 112 were not disposed was formed on the positive electrode 11. An end of a ribbon-like positive electrode lead (width: 1.0 mm, thickness: 0.05 mm) was connected to the second exposed part 111a.

(2) Preparation of Negative Electrode

A negative electrode slurry was prepared by mixing 100 parts by mass of an artificial graphite powder used as a negative electrode active material, 1 part by mass of a styrene-methacrylic acid-butadiene copolymer (SBR) used as a binding agent, and 1 part by mass of CMC used as a thickener with one another and dispersing the resulting mixture in deionized water. The negative electrode slurry was applied onto both of the surfaces of a copper foil (thickness: 6 μm) used as a negative electrode current collector 121. After drying had been performed, compression was performed in the thickness direction. Hereby, a negative electrode 12 (thickness: 0.11 mm) was prepared. When the negative electrode 12 was prepared, regions (a first exposed part 121a and a third exposed part 121b) in which negative electrode mixture layers 122 were not disposed was formed on the negative electrode 12. An end of a ribbon-like negative electrode current collection lead 70 (width: 1.5 mm, thickness: 0.1 mm) was connected to the first exposed part 121a.

(3) Preparation of Separator

A polyethylene microporous membrane (thickness: 15 μm) was prepared.

(4) Preparation of Electrode Group

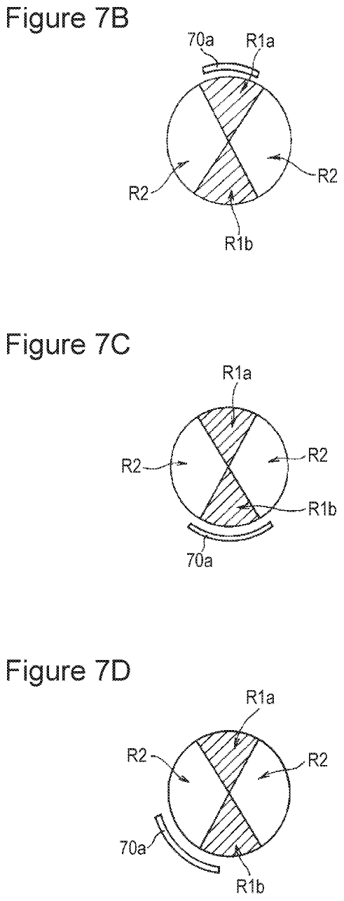

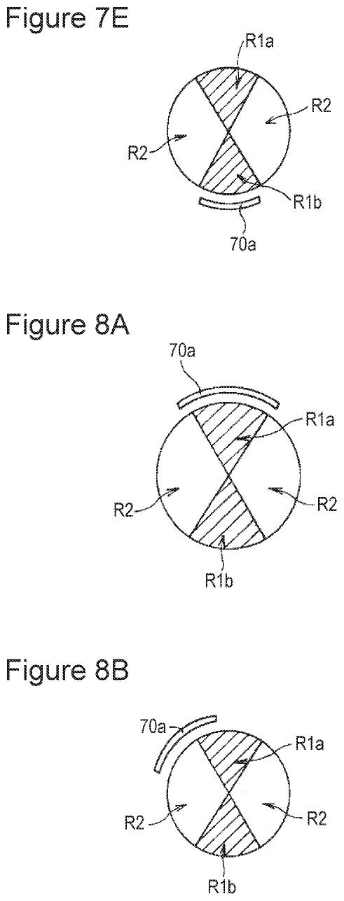

The positive electrode 11, the negative electrode 12, and the separator 13 were wound into a spiral to form a wound electrode group 10. An insulating tape 14 was attached to the winding end so as to cover the overlap part 70a of the negative electrode current collection lead 70 in order to fix the electrode group 10. The number of times the positive electrode 11 is stacked was 4 to 6. The overlap part 70a of the negative electrode current collection lead 70 was located above the second columnar region R2 as illustrated in FIG. 7A.

(5) Preparation of Nonaqueous Electrolyte

A nonaqueous electrolyte was prepared by dissolving LiPF₆ in a mixed solvent containing EC and DEC at a mass ratio of 1:1. The concentration of LiPFE in the nonaqueous electrolyte was 1.0 mol/L.

(6) Preparation of Cylindrical Lithium-Ion Secondary Battery

The electrode group 10 prepared in (4) was inserted into a closed-end cylindrical battery casing 20 (outside diameter: 4.6 mm) that had an opening and was formed of a nickel-coated iron plate. The other end of the negative electrode current collection lead 70 was welded to the inner wall of the battery casing 20 at a welding point 70c. The welding point 70c was located at a position closer to the opening of the battery casing 20 than the upper end surface of the electrode group 10. An insulating ring 50 was disposed on the upper portion of the electrode group 10. The other end of the positive electrode current collection lead 60 drawn from the electrode group 10 was connected to the bottom surface of the sealing member 40 through a hole formed in the insulating ring 50. In this step, a ring-like insulating gasket 30 was attached onto the periphery of the sealing member 40. Subsequently, 68 μL (2.1 μL per discharge capacity of 1 mAh) of the nonaqueous electrolyte prepared in (5) was charged into the battery casing 20. The iron sealing member 40 coated with nickel was attached to the opening of the battery casing 20. Sealing was performed by crimping the opening end of the battery casing 20 onto the periphery of the sealing member 40 with the gasket 30 interposed therebetween.

Twenty cylindrical secondary batteries 100 having a nominal capacity of 35.0 mAh were prepared in the above-described manner. Table 1 summarizes the evaluation results. The diameter of the electrode group 10 was 4 mm.

### Examples 2 to 5

In Examples 2 to 5, 20 cylindrical secondary batteries 100 were prepared as in Example 1, except that the overlap part 70a of the negative electrode current collection lead 70 was arranged as illustrated in FIGS. 7B to 7E, respectively. Table 1 summarizes the results.

### Comparative Examples 1 to 3

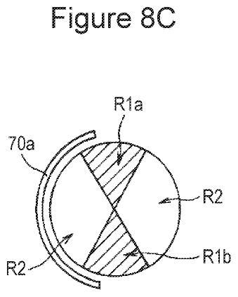

In Comparative examples 1 to 3, 20 cylindrical secondary batteries were prepared as in Example 1, except that the overlap part 70a of the negative electrode current collection lead 70 was arranged as illustrated in FIGS. 8A to 8C, respectively. The cylindrical secondary batteries were used for the evaluations. Table 1 summarizes the results.

TABLE 1

| | Position of | | |
|---|---|---|---|
| | overlap part | Evaluation 1 | |
| | of negative | (damage to | Evaluation 2 |
| | electrode cur- | negative elec- | (capacity |
| | rent collec- | trode current | retention |
| | tion lead | collector) | factor) |
| Example 1 | FIG. 7A | 0/20 | 93% |
| Example 2 | FIG. 7B | 0/20 | 85% |
| Example 3 | FIG. 7C | 0/20 | 88% |
| Example 4 | FIG. 7D | 0/20 | 90% |
| Example 5 | FIG. 7E | 0/20 | 91% |
| Comparative example 1 | FIG. 8A | 10/20 | 70% |
| Comparative example 2 | FIG. 8B | 6/20 | 72% |
| Comparative example 3 | FIG. 8C | 6/20 | 74% |

### INDUSTRIAL APPLICABILITY

The cylindrical secondary battery according to the embodiment of the present invention is excellent in terms of charge-discharge cycle characteristics while being compact in size and light in weight and therefore can be suitably used as a power source for various types of electronic devices and, in particular, for various types of portable electronic devices [including glasses (e.g., 3D glasses), a hearing aid, a stylus pen, a wearable terminal, and the like] that require a compact power source.

### REFERENCE SIGNS LIST

10 WOUND ELECTRODE GROUP
11 POSITIVE ELECTRODE
R1 FIRST COLUMNAR REGION
R1A 1A ARC COLUMN REGION
R1B 1B ARC COLUMN REGION
R2 SECOND COLUMNAR REGION
111 POSITIVE ELECTRODE CURRENT COLLECTOR
111a SECOND EXPOSED PART
111b, 111c END SURFACE
112 POSITIVE ELECTRODE MIXTURE LAYER
12 NEGATIVE ELECTRODE
12X THIRD PRINCIPAL SURFACE
12Y FOURTH PRINCIPAL SURFACE
121 NEGATIVE ELECTRODE CURRENT COLLECTOR
121a FIRST EXPOSED PART
121b THIRD EXPOSED PART
121c, 121d, 121e, 121f END SURFACE
122 NEGATIVE ELECTRODE MIXTURE LAYER
13 SEPARATOR
14 INSULATING TAPE
100 CYLINDRICAL SECONDARY BATTERY
20 BATTERY CASING
30 GASKET
40 SEALING MEMBER
40a BRIM
40b, 40c TERMINAL PARTS
50 INSULATING RING
60 POSITIVE ELECTRODE CURRENT COLLECTION LEAD
70 NEGATIVE ELECTRODE CURRENT COLLECTION LEAD
70a OVERLAP PART
70b LEAD-OUT PART
70c WELDING POINT

1. A cylindrical secondary battery comprising:
a closed-end cylindrical battery casing having an opening;
an electrode group disposed in the battery casing, the electrode group including a positive electrode, a negative electrode, and a separator interposed between the positive electrode and the negative electrode;
a nonaqueous electrolyte disposed in the battery casing;
a sealing member filling the opening of the battery casing; and
a negative electrode current collection lead connecting the negative electrode and the battery casing to each other,
wherein the positive electrode includes a positive electrode current collector and positive electrode mixture layers disposed on respective principal surfaces of the positive electrode current collector,
wherein the negative electrode includes a negative electrode current collector and negative electrode mixture layers disposed on respective principal surfaces of the negative electrode current collector,
wherein the electrode group is formed as a result of the positive electrode and the negative electrode being wound into a spiral with the separator interposed therebetween and includes a first columnar region in which the number of times the positive electrode mixture layers are stacked in the radial direction of the electrode group is highest and a second columnar region other than the first columnar region,
wherein the first columnar region includes a 1A arc column region that includes an outer periphery-side end surface of the positive electrode mixture layers and a 1B arc column region that does not include the end surface,
wherein the 1A arc column region and the 1B arc column region are arranged to face each other such that the central angles thereof are vertically opposite to each other,
wherein the negative electrode current collector includes a first exposed part on which the negative electrode mixture layers are not disposed, the first exposed part being located on the outermost periphery of the negative electrode,
wherein the negative electrode current collection lead includes an overlap part that overlaps the first exposed part and a lead-out part protruded from the first exposed part,
wherein the overlap part of the negative electrode current collection lead is not located on the boundary between the 1A arc column region and the second columnar region of the electrode group,
wherein the number of times the positive electrode mixture layers are stacked in the radial direction of the electrode group is 6 or more and 20 or less, and
wherein the cylindrical secondary battery has an outside diameter of 6.5 mm or less.

2. The cylindrical secondary battery according to claim 1, wherein the overlap part is located in a region other than the 1A arc column region.

3. The cylindrical secondary battery according to claim 1, wherein the overlap part is not located on the boundary between the 1B arc column region and the second columnar region of the electrode group.

4. The cylindrical secondary battery according to claim 1, wherein the overlap part is located in a region other than the 1B arc column region.

5. The cylindrical secondary battery according to claim 1, wherein the first exposed part is formed at an end of the negative electrode in a winding direction, the end being located on the outermost periphery of the negative electrode, so as to extend from an end of the negative electrode current collector in a winding axis direction to the other end of the negative electrode current collector.

6. The cylindrical secondary battery according to claim 1, wherein the length of the overlap part in a winding direction is 10% or more and 30% or less of the length of the outermost periphery of the electrode group in the winding direction.

7. The cylindrical secondary battery according to claim 1, wherein the outermost periphery of the electrode group is covered with the first exposed part.

8-9. (canceled)

10. The cylindrical secondary battery according to claim 1, further comprising a positive electrode current collection lead connecting the positive electrode and the sealing member to each other,
wherein the positive electrode current collector includes a second exposed part on which the positive electrode mixture layers are not disposed,
wherein the positive electrode current collection lead is joined to the second exposed part, and
wherein the second exposed part is arranged to extend in a winding direction of the positive electrode current collector along an end of the positive electrode current collector, the end facing the opening of the battery casing.

11. The cylindrical secondary battery according to claim 1, wherein the thickness of the negative electrode current collection lead is 0.3% to 3% of the outside diameter of the cylindrical secondary battery.

12. The cylindrical secondary battery according to claim 1, further comprising an insulating tape disposed on the outermost periphery of the electrode group,
wherein the insulating tape covers the overlap part of the negative electrode current collection lead and fixes the winding end of the electrode group in position, and
wherein the length of the insulating tape in a winding direction is 50% or more of the length of the outermost periphery of the electrode group in the winding direction.

13. The cylindrical secondary battery according to claim 1, wherein a material constituting the battery casing includes stainless steel.

14. The cylindrical secondary battery according to claim 1, wherein the electrode group has a diameter of 1 mm or more and 6 mm or less.

15. The cylindrical secondary battery according to claim 1, wherein one of the positive electrode mixture layers disposed on one of the surfaces of the positive electrode current collector has a thickness of 20 μm or more and 100 μm or less.

16. The cylindrical secondary battery according to claim 1, wherein one of the negative electrode mixture layers disposed on one of the surfaces of the negative electrode current collector has a thickness of 20 μm or more and 120 μm or less.
